(19) United States
(12) Patent Application Publication
(10) Pub. No.: US 2014/0049706 A1
(43) Pub. Date: Feb. 20, 2014

(54) Stereoscopic Image Display Device

(71) Applicant: LG DISPLAY CO., LTD., Seoul (KR)

(72) Inventors: HyungJu Park, Gyeonggi-do (KR); ByungJoo Lee, Seoul (KR)

(73) Assignee: LG DISPLAY CO., LTD., Seoul (KR)

(21) Appl. No.: 13/672,960

(22) Filed: Nov. 9, 2012

(30) Foreign Application Priority Data
Aug. 16, 2012 (KR) 10-2012-0089497

(51) Int. Cl. G02B 27/22; G02F 1/1335

(52) U.S. Cl. CPC G02B 27/22; G02F 1/133526
USPC 349/15; 349/200

(57) ABSTRACT

A stereoscopic image display device includes a first liquid crystal lens to convert a light component of a first direction in a non-polarized light source into a first output light of the first direction, and to output the first output light; a second liquid crystal lens to convert a light component of a second direction in the non-polarized light source into a second output light of the first direction; and a display panel below the first liquid crystal lens and second liquid crystal lens.

This application claims the benefit of the Korean Patent Application No. 10-2012-0089497 filed on Aug. 16, 2012, which is hereby incorporated by reference as if fully set forth herein.

### BACKGROUND OF THE INVENTION

1. Field of the Invention

The present invention relates to a stereoscopic image display device, and more particularly, to a glasses-free stereoscopic image display device (autostereoscopic display device).

2. Discussion of the Related Art

Recently, there is a growing demand for devices to display stereoscopic images. In particular, demand for three-dimensional (3D) images has increased for various display devices in advertisement, households, the medical field, education, exhibition environments, broadcasting, videoconferencing, etc. To satisfy such demand, a stereoscopic image display device capable of displaying the 3D images has been studied and developed steadily.

The stereoscopic image display device realizes 3D images through stereoscopic technique (stereoscopic method) or autostereoscopic technique (autostereoscopic method). The stereoscopic method may use parallax images of left and right eyes, which may be classified into a glasses method and a glasses-free method. The glasses method may realize the 3D images by changing a polarizing direction of parallax images of left and right eyes in a direct type display device or projector, or performing a time division method, through the use of polarizing glasses or shutter glasses. The glasses-free method may realize the 3D images by providing optical elements such as parallax barrier and lenticular lens in a front or rear side of a display screen to separate optical axes of parallax images of left and right eyes.

The above method using the lenticular lens may realize the 3D image by providing images separately to the left eye and right eye of viewer through the use of lenticular lens. However, only a 3D image can be displayed because it is impossible that light separation of the lenticular lens is selectively turned-on/off. That is, it is disadvantageous in that it is impossible to selectively realize the 3D image or 2D image.

To overcome these problems, a method for electrically controlling a refractive index of liquid crystal has been proposed to selectively display the 2D image or 3D image through the use of lenticular lens. However, the stereoscopic image display device according to the related art is disadvantageous in that it necessarily requires an additional polarizing plate for separation of non-polarized light source. Thus, various methods for compensating this defect are being researched and studied.

### SUMMARY OF THE INVENTION

Accordingly, the present invention is directed to a stereoscopic image display device that substantially obviates one or more problems due to limitations and disadvantages of the related art.

An object of the present invention is to provide a stereoscopic image display device to enhance light efficiency without using an additional polarizing plate.

Another object of the present invention is to provide a stereoscopic image display device to reduce a manufacturing cost and to selectively realize 2D image or 3D image according to user's choice.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described herein, a stereoscopic image display device includes a first liquid crystal lens to convert a light component of a first direction in a non-polarized light source into a first output light of the first direction, and to output the first output light; a second liquid crystal lens to convert a light component of a second direction in the non-polarized light source into a second output light of the first direction; and a display panel below the first liquid crystal lens and second liquid crystal lens.

In another aspect, a lens system for a stereoscopic image display device includes a first liquid crystal lens to convert a light component of a first direction in a non-polarized light source into a first output light of the first direction, and to output the first output light; and a second liquid crystal lens to convert a light component of a second direction in the non-polarized light source into a second output light of the first direction.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross sectional view of a stereoscopic image display device according to one example of an embodiment according to the present invention;

FIG. 2 is a cross sectional view of a stereoscopic image display device according to another example embodiment according to the present invention;

FIG. 3 illustrates an optical path of a liquid crystal lens;

FIGS. 4A and 4B illustrate an optical path according to whether or not a voltage is applied in the stereoscopic image display device according to one example embodiment according to the present invention; and

FIGS. 5A and 5B illustrate an optical path according to whether or not a voltage is applied in the stereoscopic image display device according to another example embodiment according to the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

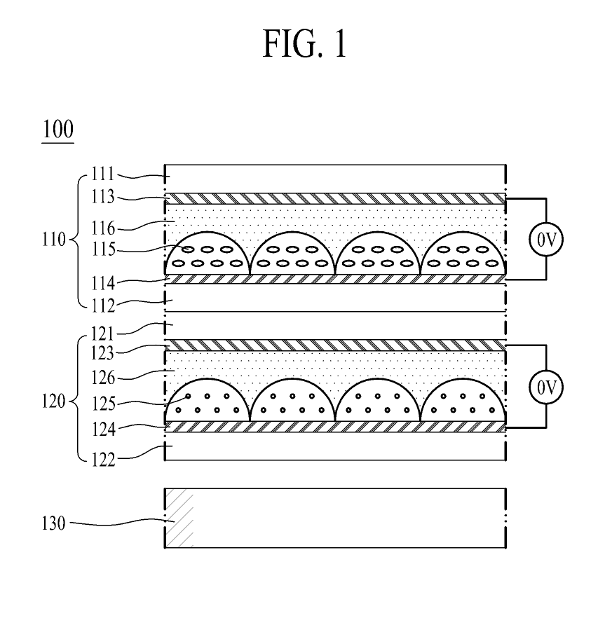

FIG. 1 is a cross sectional view of a stereoscopic image display device according to one example embodiment according to the present invention.

As shown in FIG. 1, the stereoscopic image display device 100 includes a first liquid crystal lens 110, a second liquid crystal lens 120, and a display panel 130. The first liquid crystal lens 110 and second liquid crystal lens 120 may respectively comprise lenticular liquid crystal layers 115 and 125, and resin layers 116 and 126. That is, the first liquid crystal lens 110 includes a first substrate 111, and a second substrate 112 confronting the first substrate 111, wherein the lenticular liquid crystal layer 115 and resin layer 116 are formed between a first electrode 113 on a lower surface of the first substrate 111 and a second electrode 114 on an upper surface of the second substrate 112. Also, the second liquid crystal lens 120 includes a third substrate 121, and a fourth substrate 122 confronting the third substrate 121, wherein the lenticular liquid crystal layer 125 and resin layer 126 are formed between a third electrode 123 on a lower surface of the third substrate 121 and a fourth electrode 124 on an upper surface of the fourth substrate 122.

The lenticular liquid crystal layers 115 and 125 may be formed of a liquid crystal material with birefringence to realize 2D images by displaying output images on the display panel as it is, or to realize 3D images by refracting the output images. In accordance with conditions and design specifications, various kinds of liquid crystal material may be used, for example, nematic liquid crystal material of positive liquid crystal or negative liquid crystal. In this case, the positive liquid crystal may be defined such that a dielectric constant (ε) in the direction of long axis is larger than a dielectric constant in the direction of short axis, that is, Δε (difference of dielectric constant)>0. Meanwhile, the negative liquid crystal may be defined such that a dielectric constant in the direction of short axis is larger than a dielectric constant in the direction of long axis.

In FIG. 1, the first electrode 113 is formed on the lower surface of the first substrate 111, and the third electrode 123 is formed on the lower surface of the third substrate 121. However, for example, a lenticular electrode may be formed between the liquid crystal layer and resin layer. That is, the first electrode 113 and third electrode 123 may be respectively formed between the lenticular liquid crystal layer 115 and 125 and resin layer 116 and 126.

The resin layer 116 and 126 may be formed of transparent polymer resin, for example, acryl-based resin. However, the material of resin layer 116 and 126 is not limited to above, and the resin layer 116 and 126 may be formed of various kinds of materials.

Although not shown, the first liquid crystal lens 110 and second liquid crystal lens 120 may further include an alignment film (not shown) for setting a pre-tilt angle of liquid crystal. A lower alignment film (not shown) may be formed on each of the second electrode 114 and fourth electrode 124, and an upper alignment film (not shown) may be formed between the liquid crystal layer 115 and 125 and resin layer 116 and 126. The alignment film may be formed of polyimide. Generally, a rubbing method may be used to align the alignment film, wherein the rubbing method is provided to control directionality of the liquid crystal through by physical rubbing. In the rubbing method, the liquid crystal may be aligned in only one direction. If using a UV alignment method corresponding to a non-contact method, the liquid crystal can be aligned in the different directions. However, the alignment method is not limited to the above, and the liquid crystal may be aligned by the various alignment methods.

When a voltage or electric field is applied to the lenticular liquid crystal layer 115 and 125, a refractive index can be selectively charged, thereby keeping light straight or refracting light while passing through the lenticular shape.

Accordingly, due to the lenticular liquid crystal layer 115 and 125, the stereoscopic image display device 100 functions as a lens depending on whether or not the voltage is applied so that it is possible to refract the light output from the display panel 130, thereby achieving the 3D images.

Due to refractive index anisotropy of the liquid crystal material, the lenticular liquid crystal layer 115 and 125 may have first refractive index (nₑ) and second refractive index (nₒ), wherein the first refractive index (nₑ) is shown in the direction of long axis of liquid crystal material, and the second refractive index (nₒ) is shown in the direction of short axis of liquid crystal material. Also, the resin layer 116 and 126 may have the second refractive index (nₒ) which is smaller than the first refractive index (nₑ).

Accordingly, the stereoscopic image display device 100 may selectively realize the 2D image or 3D image through the above difference of refractive indexes.

The first substrate 111, second substrate 112, third substrate 121, and fourth substrate 122 may be formed of glass or transparent plastic. Also, the first electrode 113, second electrode 114, third electrode 114, and fourth electrode 124 may be formed of a transparent conductive material, such as indium tin oxide (ITO) or indium zinc oxide (IZO).

In accordance with conditions and design specifications in the first liquid crystal lens 110 and second liquid crystal lens 120, a radius of curvature, pitch and sag can be adjusted, thereby providing the first liquid crystal lens 110 and second liquid crystal lens 120 whose distances to the pixel are different from each other.

Also, the display panel 130 may use various display types, for example, liquid crystal display (LCD), field emission display (FED), plasma display panel (PDP), organic light emitting diode display (OLED), electrophoresist display (EPD), etc., wherein the display panel 130 displays video information through the use of pixels.

A related art display panel is provided with a structure where a liquid crystal layer is formed between a TFT substrate with a pixel array formed thereon and a color filter substrate for realizing colors, wherein the TFT substrate and color filter substrate confront each other, and a polarizing plate whose optical absorption axis is at 90° is formed on each surface of the TFT substrate and color filter substrate. Thus, in the related art display panel, light incident in any one direction of horizontal direction and vertical direction on the display panel is linearly polarized in the direction of 90° with respect to the optical absorption axis, whereby the light comes out of the display panel.

However, the display panel 130 can be realized without an additional polarizing plate. That is, because there is no requirement for the high-priced polarizing plate, the display panel 130 can utilize a non-polarized light source as it is.

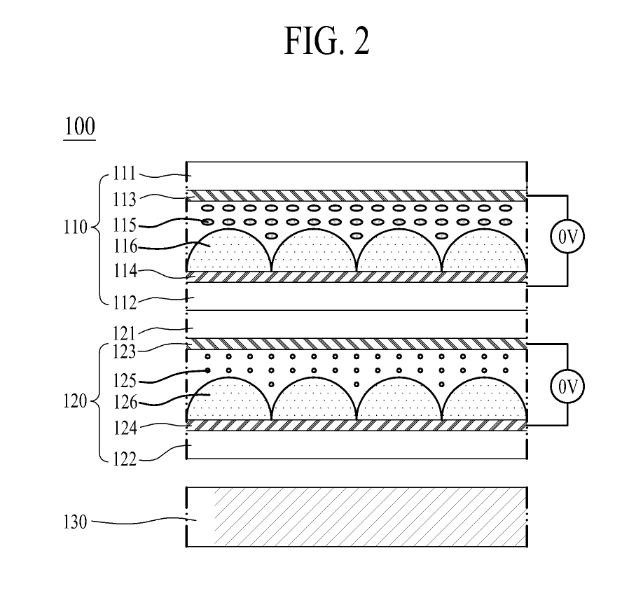

FIG. 2 is a cross sectional view of a stereoscopic image display device according to another example embodiment according to the present invention.

As shown in FIG. 2, the stereoscopic image display device 100 includes a first liquid crystal lens 110, a second liquid crystal lens 120, and a display panel 130.

Except lenticular resin layers 116 and 126 and liquid crystal layers 115 and 125, other structures and their properties in the stereoscopic image display device 100 according to another embodiment of the present invention are identical to those in the stereoscopic image display device according to one embodiment of the present invention.

The first liquid crystal lens 110 and second liquid crystal lens 120 may respectively comprise the lenticular resin layers 116 and 126 and liquid crystal layers 115 and 125. That is, the first liquid crystal lens 110 includes a first substrate 111, and a second substrate 112 confronting the first substrate 111, wherein the liquid crystal layer 115 and lenticular resin layer 116 are formed between a first electrode 113 on a lower surface of the first substrate 111 and a second electrode 114 on an upper surface of the second substrate 112. Also, the second liquid crystal lens 120 includes a third substrate 121, and a fourth substrate 122 confronting the third substrate 121, wherein the liquid crystal layer 125 and lenticular resin layer 126 are formed between a third electrode 123 on a lower surface of the third substrate 121 and a fourth electrode 124 on an upper surface of the fourth substrate 122.

In FIG. 2, the second electrode 114 is formed on the second substrate 112, and the fourth electrode 124 is formed on the fourth substrate 122. However, for example, a lenticular electrode may be formed between the liquid crystal layer and resin layer. That is, the second electrode 114 and fourth electrode 124 may be respectively formed between the liquid crystal layer 115 and 125 and lenticular resin layer 116 and 126.

Although not shown, the first liquid crystal lens 110 and second liquid crystal lens 120 may further include an alignment film (not shown) for setting a pre-tilt angle of liquid crystal. An upper alignment film (not shown) may be formed under each of the first electrode 113 and third electrode 123, and a lower alignment film (not shown) may be formed between the liquid crystal layer 115 and 125 and resin layer 116 and 126.

When a voltage or electric field is applied to the liquid crystal layer 115 and 125, a refractive index can be selectively changed, thereby keeping light straight or refracting light while passing through the lenticular shape.

Accordingly, due to the lenticular resin layer 116 and 126, the stereoscopic image display device 100 functions as a lens depending on whether or not the voltage is applied so that it is possible to refract the light output from the display panel 130, thereby achieving the 3D images.

Due to refractive index anisotropy of the liquid crystal material, the liquid crystal layer 115 and 125 may have first refractive index (nₑ) and second refractive index (nₒ), wherein the first refractive index (nₑ) is shown in the direction of long axis of liquid crystal material, and the second refractive index (nₒ) is shown in the direction of short axis of liquid crystal material. Also, the lenticular resin layer 116 and 126 may have the first refractive index (nₑ) which is larger than the second refractive index (nₒ).

Accordingly, the stereoscopic image display device 100 may selectively realize the 2D image or 3D image through the above difference of refractive indexes.

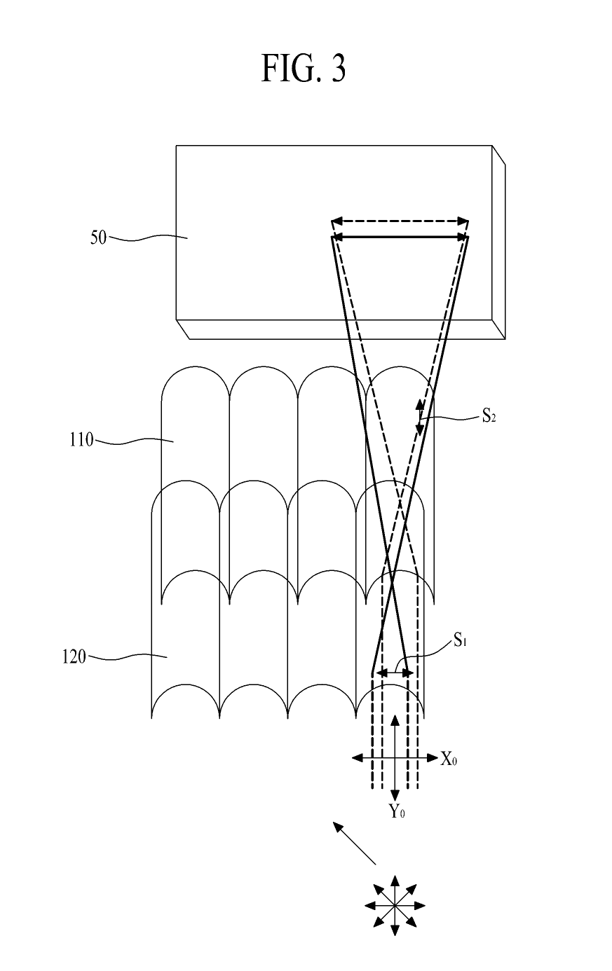

FIG. 3 illustrates an optical path of liquid crystal lens, As shown in FIG. 3, the first liquid crystal lens 110 converts a polarized light (X₀) of the first direction in the non-polarized light source into a first output light of the first direction, and then outputs the first output light to a screen 50; and the second liquid crystal lens 120 converts a polarized light (Y₀) of the second direction in the non-polarized light source into a second output light of the first direction, and then outputs the second output light to the screen 50.

As mentioned above, the first liquid crystal lens 110 and second liquid crystal lens 120 are formed in shape of lens, which function as the lenticular lens provided to realize the 3D image in the stereoscopic image display device according to the related art.

First, the non-polarized light source may have an electric field which vibrates in all directions on the plane perpendicular to the light-traveling direction. For example, on the assumption that the non-polarized light source travels in the direction of Z-axis, the light source may be scattered in the directions of X-axis and Y-axis, wherein the light source scattered in the direction of X-axis may be perpendicular to the light source scattered in the direction of Y-axis. That is, the non-polarized light source may be classified into light sources X₀ and Y₀ being incident in two directions. Also, the incident light source may be guided by any one of directional distributions of the first liquid crystal lens 110 and second liquid crystal lens 120.

Herein, the light source scattered in the direction of X-axis is defined as the polarized light (X₀) of the first direction, and the light source scattered in the direction of Y-axis is defined as the polarized light (Y₀) of the second direction.

The first liquid crystal lens 110 guides the polarized light of a specific direction in the non-polarized light source. Thus, the first liquid crystal lens 110 guides the polarized light (X₀) of the first direction, that is, the polarized light (Y₀) of the second direction being perpendicular to the first direction is not guided by the first liquid crystal lens 110. Also, the second liquid crystal lens 120 guides the polarized light of a specific direction in the non-polarized light source. Thus, the second liquid crystal lens 120 guides the polarized light (Y₀) of the second direction, that is, the polarized light (X₀) of the first direction being perpendicular to the second direction is not guided by the second liquid crystal lens 120.

At this time, the first liquid crystal lens 110 and second liquid crystal lens 120 are designed such that the arrangement direction of the lens shape in the first liquid crystal lens 110 is the same as that of the second liquid crystal lens 120, and the alignment direction of liquid crystal material in the first liquid crystal lens 110 is perpendicular to that of the second liquid crystal lens 120. That is, a slow axis S₁ for the liquid crystal material of the first liquid crystal lens 110 is perpendicular to a slow axis S₂ for the liquid crystal material of the second liquid crystal lens 120.

Accordingly, the light is output in one direction, i.e., a first direction to the screen 50 through the use of first liquid crystal lens 110 and second liquid crystal lens 120. That is, the first liquid crystal lens 110 converts the polarized light (X₀) of the first direction into a first output light of the first direction in parallel, and then outputs the first output light to the screen 50; and the second liquid crystal lens 120 converts the polarized light (Y₀) of the second direction into a second output light of the first direction in perpendicular, and then outputs the second output light to the screen 50.

Thus, it is possible to realize the image through the first output light and second output light with one direction from the non-polarized light source.

The stereoscopic image display device 100 advantageously enables the use of a non-polarized light source as it is, and the selective output of both 2D images or 3D images according to whether or not the voltage is applied.

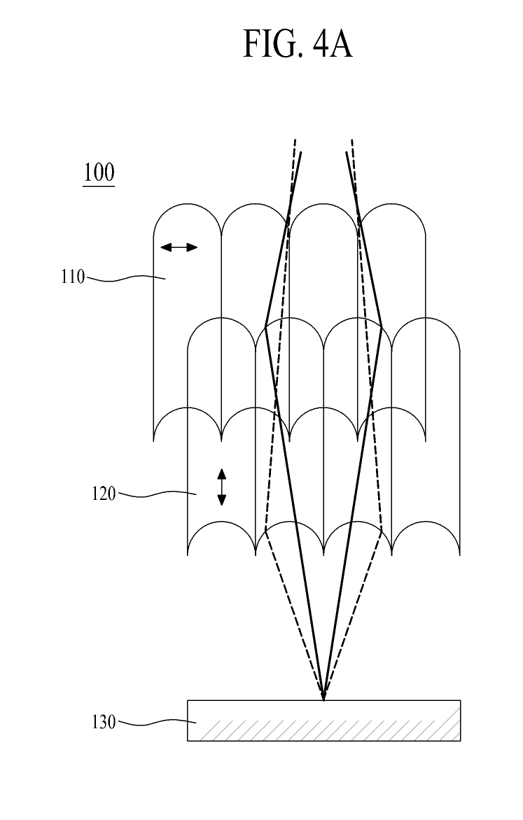

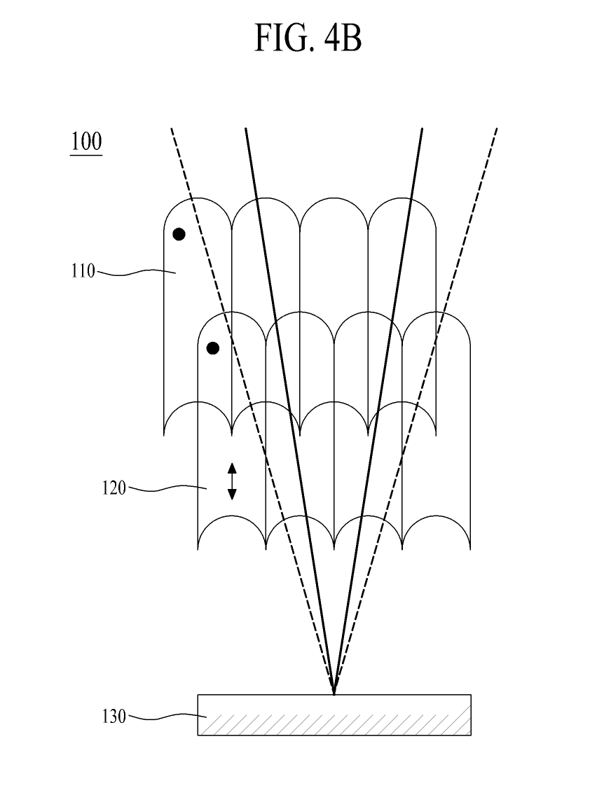

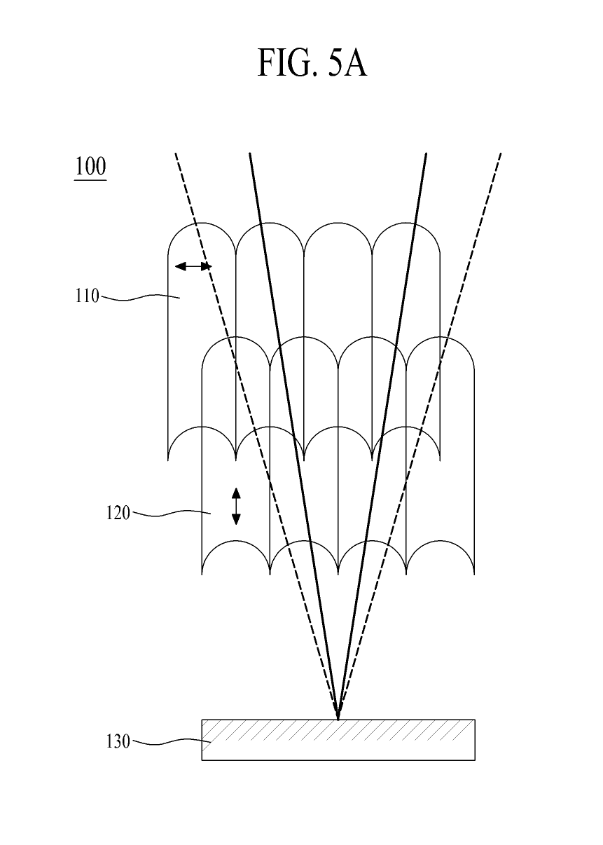

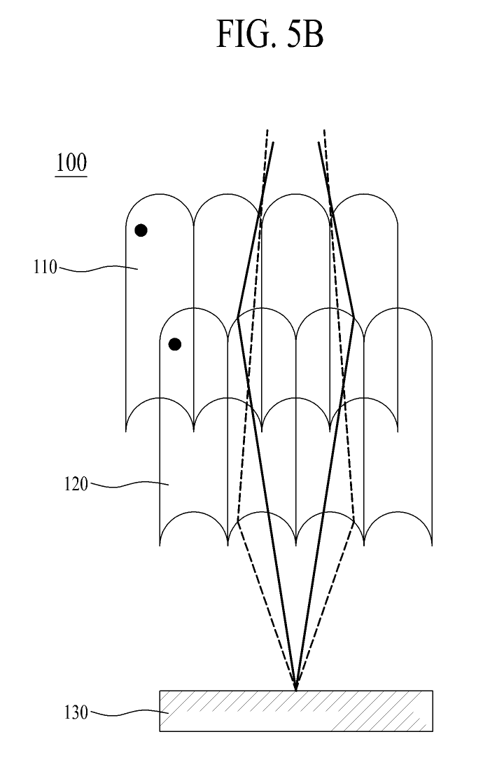

FIGS. 4A, 4B, 5A, and 5B illustrate an optical path according to whether or not the voltage is applied in the stereoscopic image display device. FIGS. 4A and 5A illustrate the optical path when the voltage is not applied to the electrodes, and FIGS. 4B and 5B illustrate the optical path when the voltage is applied to the electrodes.

As shown in FIG. 4A, when the voltage is not applied to the electrodes, the 3D images are displayed on the stereoscopic image display device 100. Meanwhile, as shown in FIG. 4B, when the voltage is applied to the electrodes, the 2D images are displayed on the stereoscopic image display device 100.

If the voltage is not applied to the electrodes, as shown in FIG. 4A, when the polarized light (X₀) of the first direction passes through the first liquid crystal lens 110, the polarized light (X₀) of the first direction is transmitted while also being refracted due to the difference between the first refractive index (nₑ) of liquid crystal material and the second refractive index (nₒ) of resin layer. Also, when the polarized light (Y₀) of the second direction passes through the second liquid crystal lens 120, the polarized light (Y₀) of the second direction is transmitted while also being refracted due to the difference between the first refractive index (nₑ) of liquid crystal material and the second refractive index (nₒ) of resin layer.

If the voltage is applied to the electrodes, as shown in FIG. 4B, when the polarized light (X₀) of the first direction passes through the first liquid crystal lens 110, the polarized light (X₀) of the first direction is transmitted without being refracted because the second refractive index (nₒ) of liquid crystal material is the same as the second refractive index (nₒ) of resin layer. Also, when the polarized light (Y₀) of the second direction passes through the second liquid crystal lens 120, the polarized light (Y₀) of the second direction is transmitted without being refracted because the second refractive index (nₒ) of liquid crystal material is the same as the second refractive index (nₒ) of resin layer.

In FIG. 4A where the voltage is not applied to the electrodes under the condition the liquid crystal material is maintained in its initial alignment direction, left-eye image information and right-eye image information may be separated through the use of resin layers, so that left and right eyes of viewer may discern different kinds of information, and then image information of different kinds being separated into the both eyes may be combined in the brain, thereby realizing 3D images. In FIG. 4B where the voltage is applied to the electrodes, the direction of output light is parallel with the alignment direction of liquid crystal material, so that the 2D images are displayed as is.

As shown in FIG. 5A, when the voltage is not applied to the electrodes, the 2D images are displayed on the stereoscopic image display device 100. Meanwhile, as shown in FIG. 5B, when the voltage is applied to the electrodes, the 3D images are displayed on the stereoscopic image display device 100.

If the voltage is not applied to the electrodes, as shown in FIG. 5A, when the polarized light (X₀) of the first direction passes through the first liquid crystal lens 110, the polarized light (X₀) of the first direction is transmitted without being refracted because the first refractive index (nₑ) of liquid crystal material is the same as the first refractive index (nₑ) of resin layer. Also, when the polarized light (Y₀) of the second direction passes through the second liquid crystal lens 120, the polarized light (Y₀) of the second direction is transmitted without being refracted because the first refractive index (nₑ) of liquid crystal material is the same as the first refractive index (nₑ) of resin layer.

If the voltage is applied to the electrodes, as shown in FIG. 5B, when the polarized light (X₀) of the first direction passes through the first liquid crystal lens 110, the polarized light (X₀) of the first direction is transmitted while also being refracted due to the difference between the second refractive index (nₒ) of liquid crystal material and the first refractive index (nₑ) of resin layer. Also, when the polarized light (Y₀) of the second direction passes through the second liquid crystal lens 120, the polarized light (Y₀) of the second direction is transmitted while also being refracted due to the difference between the second refractive index (nₒ) of liquid crystal material and the first refractive index (nₑ) of resin layer.

In FIG. 5A where the voltage is not applied to the electrodes under the condition the liquid crystal material is maintained in its initial alignment direction, the direction of output light is parallel with the alignment direction of liquid crystal material, so that the 2D images are displayed as is. In FIG. 5B where that the voltage is applied to the electrodes, left-eye image information and right-eye image information may be separated through the use of resin layers, so that left and right eyes of viewer may discern different kinds of information, and then image information of different kinds being separated into the both eyes may be combined in the brain, thereby realizing the 3D images.

Accordingly, the stereoscopic image display device 100 uses the non-polarized light source as it is, and improves the light efficiency without additionally using the high-priced polarizing plate. Also, the stereoscopic image display device 100 reduces manufacturing costs by minimizing power consumption and enables the selective realization of 2D images or 3D images according to a user's choice.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A stereoscopic image display device, comprising:
a first liquid crystal lens to convert a light component of a first direction in a non-polarized light source into a first output light of the first direction, and to output the first output light;
a second liquid crystal lens to convert a light component of a second direction in the non-polarized light source into a second output light of the first direction; and
a display panel below the first liquid crystal lens and second liquid crystal lens.

2. The stereoscopic image display device according to claim 1, wherein the first liquid crystal lens and second liquid crystal lens have the same arrangement direction of lens shape.

3. The stereoscopic image display device according to claim 1, wherein the first direction is perpendicular to the second direction.

4. The stereoscopic image display device according to claim 1, wherein each of the first liquid crystal lens and second liquid crystal lens includes a lenticular liquid crystal layer and a resin layer.

5. The stereoscopic image display device according to claim 4, wherein an alignment direction of a liquid crystal material in the lenticular liquid crystal layer of the first liquid crystal lens is perpendicular to an alignment direction of a liquid crystal material in the lenticular liquid crystal layer of the second liquid crystal lens.

6. The stereoscopic image display device according to claim 4,
wherein the first liquid crystal lens comprises:
first and second substrates confronting each other;
a first electrode on a lower surface of the first substrate; and
a second electrode on an upper surface of the second substrate, wherein the liquid crystal layer and resin layer are formed between the first and second electrodes, and
wherein the second liquid crystal lens comprises:
third and fourth substrates confronting each other;
a third electrode on a lower surface of the third substrate; and
a fourth electrode on an upper surface of the fourth substrate, wherein the liquid crystal layer and resin layer are formed between the third and fourth electrodes.

7. The stereoscopic image display device according to claim 6, wherein a 2D image is realized when a voltage is applied to the first electrode, second electrode, third electrode and fourth electrode, and a 3D image is realized when the voltage is not applied thereto.

8. The stereoscopic image display device according to claim 4, wherein when a voltage is not applied to the first and second liquid crystal lenses, light is refracted by first and second liquid crystal lenses to operate in a 3D display mode, and
wherein when a voltage is applied to the first and second liquid crystal lenses, light is not refracted by first and second liquid crystal lenses to operate in a 2D display mode.

9. The stereoscopic image display device according to claim 4, wherein the lenticular liquid crystal layer and the resin layer of each of the first and second liquid crystal lenses are disposed between electrodes.

10. The stereoscopic image display device according to claim 1, wherein each of the first liquid crystal lens and second liquid crystal lens includes a lenticular resin layer and a liquid crystal layer.

11. The stereoscopic image display device according to claim 10, wherein an alignment direction of a liquid crystal material in the liquid crystal layer of the first liquid crystal lens is perpendicular to an alignment direction of a liquid crystal material in the liquid crystal layer of the second liquid crystal lens.

12. The stereoscopic image display device according to claim 10,
wherein the first liquid crystal lens comprises:
first and second substrates confronting each other;
a first electrode on a lower surface of the first substrate; and
a second electrode on an upper surface of the second substrate, wherein the liquid crystal layer and resin layer are formed between the first and second electrodes, and
wherein the second liquid crystal lens comprises:
third and fourth substrates confronting each other;
a third electrode on a lower surface of the third substrate; and
a fourth electrode on an upper surface of the fourth substrate, wherein the liquid crystal layer and resin layer are formed between the third and fourth electrodes.

13. The stereoscopic image display device according to claim 12, wherein a 2D image is realized when a voltage is not applied to the first electrode, second electrode, third electrode and fourth electrode, and a 3D image is realized when the voltage is applied thereto.

14. The stereoscopic image display device according to claim 10, wherein when a voltage is applied to the first and second liquid crystal lenses, light is refracted by first and second liquid crystal lenses to operate in a 3D display mode, and
wherein when a voltage is not applied to the first and second liquid crystal lenses, light is refracted by first and second liquid crystal lenses to operate in a 2D display mode.

15. The stereoscopic image display device according to claim 10, wherein the lenticular resin layer and the liquid crystal layer of each of the first and second liquid crystal lenses are disposed between electrodes.

16. A lens system for a stereoscopic image display device, comprising:
a first liquid crystal lens to convert a light component of a first direction in a non-polarized light source into a first output light of the first direction, and to output the first output light; and
a second liquid crystal lens to convert a light component of a second direction in the non-polarized light source into a second output light of the first direction.

17. The lens system according to claim 16, wherein each of the first liquid crystal lens and second liquid crystal lens includes a lenticular liquid crystal layer and a resin layer.

18. The lens system according to claim 17, wherein when a voltage is not applied to the first and second liquid crystal lenses, light is refracted by first and second liquid crystal lenses to operate in a 3D display mode, and
wherein when a voltage is applied to the first and second liquid crystal lenses, light is not refracted by first and second liquid crystal lenses to operate in a 2D display mode.

19. The lens system according to claim 16, wherein each of the first liquid crystal lens and second liquid crystal lens includes a lenticular resin layer and a liquid crystal layer.

20. The lens system according to claim 19, wherein when a voltage is applied to the first and second liquid crystal lenses, light is refracted by first and second liquid crystal lenses to operate in a 3D display mode, and
wherein when a voltage is not applied to the first and second liquid crystal lenses, light is refracted by first and second liquid crystal lenses to operate in a 2D display mode.
